(19) United States
(12) Patent Application Publication
(10) Pub. No.: US 2014/0365456 A1
(43) Pub. Date: Dec. 11, 2014

(54) ITEM-BASED RECOMMENDATION ENGINE FOR RECOMMENDING A HIGHLY-ASSOCIATED ITEM

(71) Applicant: Min Jae Lee, Seoul (KR)

(72) Inventor: Min Jae Lee, Seoul (KR)

(73) Assignee: NEOWIZ INTERNET CORPORATION, Seoul (KR)

(21) Appl. No.: 14/241,193

(22) PCT Filed: Aug. 27, 2012
(86) PCT No.: PCT/KR2012/006821

§ 371 Date: Feb. 26, 2014

(30) Foreign Application Priority Data
Aug. 26, 2011 (KR) 10-2011-0085780

(51) Int. Cl. G06F 17/30

(52) U.S. Cl. CPC G06F 17/30864
USPC 707/706

(57) ABSTRACT

Disclosed relates to a recommendation engine. The recommendation engine includes a query generation module configured to store a plurality of item vectors as a plurality of documents, configured to search for a reference document associated with the reference item among the plurality of the documents to extract a reference item vector and configured to generate a query including at least one user best associated with the extracted reference item vector if successful, each of the plurality of the item vectors corresponding to an element including a user-preference pair and a search module configured to calculate a correlation between the extracted reference item vector and each of the plurality of the item vectors in the plurality of the documents based on the generated query to provide the at least one recommendation item.

### TECHNICAL FIELD

This disclosure relates to an item recommendation technology and more particularly to an item recommendation system capable of searching for a recommendation item having a high correlation to provide the recommendation item.

### BACKGROUND ART

According as a use of Internet has been increased, an offline provision of a service and a product has been performed on a web. A user may visit a specific website and may input a search word to collect data associated with the service or product and the specific website may provide another recommendation item highly associated with an item selected by the user. Such technology is disclosed to Korean Publication Patent No. 10-2001-0091506.

### TECHNICAL SOLUTION

The described technology provides a recommendation engine quickly searching a recommendation item.

In some embodiment, a recommendation engine searches for at least one recommendation item associated with a reference item being selected by a query user. The recommendation engine includes a query generation module configured to store a plurality of item vectors as a plurality of documents, configured to search for a reference document associated with the reference item among the plurality of the documents to extract a reference item vector and configured to generate a query including at least one user best associated with the extracted reference item vector if successful, each of the plurality of the item vectors corresponding to an element including a user-preference pair and a search module configured to calculate a correlation between the extracted reference item vector and each of the plurality of the item vectors in the plurality of the documents based on the generated query to provide the at least one recommendation item.

In one embodiment, the search module may calculate a correlation between a preference of the at least one user and a preference of at least one user in each of the plurality of the item vectors. In one embodiment, the correlation may be calculated by using a Pearson Coefficient. In one embodiment, the query may define each of the at least one user as a query element and the query element may include at least a corresponding preference as a boost and a corresponding user as a terminology. In one embodiment, the search module may search for at least one item vector having best ranking among the plurality of the item vectors based on the query element. In one embodiment, the ranking may be calculated based on the boost and the Pearson Coefficient.

In one embodiment, the query may define each of the at least one user as a query element and the query element may include at least a constant independent of a corresponding preference as a boost and a corresponding user as a terminology.

In one embodiment, the recommendation engine may further include a popular recommendation module configured to determine, as the at least one recommendation item, at least one item recent frequently searched in a current time window and independent of the reference item if unsuccessful.

In one embodiment, the query generation module may generate a query including the query user independent of the reference item if unsuccessful. In one embodiment, the search module may search the plurality of the item vectors for the query user to determine at least one item having a best preference as the at least recommendation item.

In one embodiment, a structure of the query may include a following tree structure.

<tree structure>

| | | |
|---|---|---|
| | the query −+−− a boost | |
| | +−− a clause −+− an element list −+− an element | −+− a type |
| | | +− a boost |
| | | +− a terminology {a user |
| field, a user} | | |

Herein, the boost may correspond to a preference, the element list may include at least one element, the type may be used to determine a terminology or a kind of operators, the user field may indicate for searching the plurality of the item vectors for a user and the user may indicate one of the at least one user.

In some embodiments, an item recommendation method is performed by a recommendation engine. The recommendation engine searches for at least one recommendation item associated with a reference item, the reference item being selected by a query user. The item recommendation method includes storing a plurality of item vectors as a plurality of documents and searching for a reference document associated with the reference item among the plurality of the documents to extract a reference item vector, generating a query including at least one user best associated with the extracted reference item vector if successful and calculating a correlation between the extracted reference item vector and each of the plurality of the item vectors in the plurality of the documents based on the generated query to provide the at least one recommendation item. Each of the plurality of the item vectors may correspond to an element including a user-preference pair.

In one embodiment, the item recommendation method may further include determining, as the at least one recommendation item, at least one item recent frequently searched in a current time window and independent of the reference item if unsuccessful.

In another embodiment, the item recommendation method may further include generating a query including the query user independent of the reference item if unsuccessful and searching the plurality of the item vectors for the query user to determine at least one item having a best preference as the at least recommendation item.

The described technology may quickly search for a recommendation item from an example embodiment of a technical solution.

### DESCRIPTION OF DRAWINGS

FIG. 1 is a diagram illustrating a recommendation system according to an embodiment of this disclosure.

FIG. 2 is a block diagram illustrating a recommendation server in FIG. 1.

FIG. 3 is a block diagram illustrating a recommendation engine of FIG. 2.

FIG. 4 is a diagram illustrating a first procedure recommending an item in a recommendation engine of FIG. 3.

FIG. 5 is a diagram illustrating a second procedure recommending an item in a recommendation engine of FIG. 3.

FIG. 6 is a diagram illustrating an example of a first procedure recommending an item of FIG. 4.

FIG. 7 is a diagram illustrating an example of a second procedure recommending an item of FIG. 5.

### BEST MODE

### Mode for Invention

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “˜ between”, “immediately ˜ between” or “adjacent to ˜” and “directly adjacent to ˜” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Reference numerals, for example, a, b, c, . . . are used for the purpose of illustration. The reference numerals do not describe an order of respective steps. The respective steps may be performed differently from an expressed order if the context does not describe a specific order. That is, the respective steps may be performed in the same order as the expressed order, may be simultaneously performed and may be performed in an opposite order.

Unless defined otherwise, the terms including technical and scientific terms used in this specification may have the meaning that can be commonly apprehended by those skilled in the art. The terms, such as the terms defined in the commonly-used dictionary, must be interpreted based on the context of the related technology and must not be interpreted ideally or excessively.

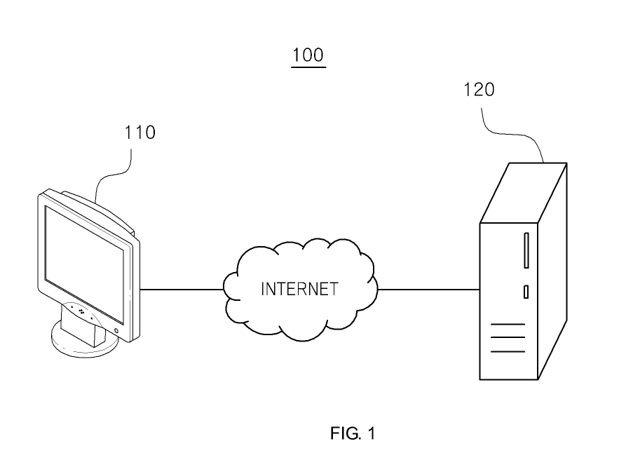

FIG. 1 is a diagram illustrating a recommendation system according to an embodiment of this disclosure.

Referring to FIG. 1, a recommendation system 100 includes a user computer 110 and a recommendation server 120.

The user computer 110 directly or indirectly accesses to the recommendation server 120 to search or select an item. The item may correspond to a product or a document being provided by the recommendation server 120.

The recommendation server 120 provides at least one recommendation item to the user computer 110 through a user or an item based recommendation. Herein, the user based recommendation may predict a preference of the user for a specific item based on a preference of other users having a preference similar to a preference of the user and the item based recommendation may predict a preference of a specific user based on a similarity of a plurality of items.

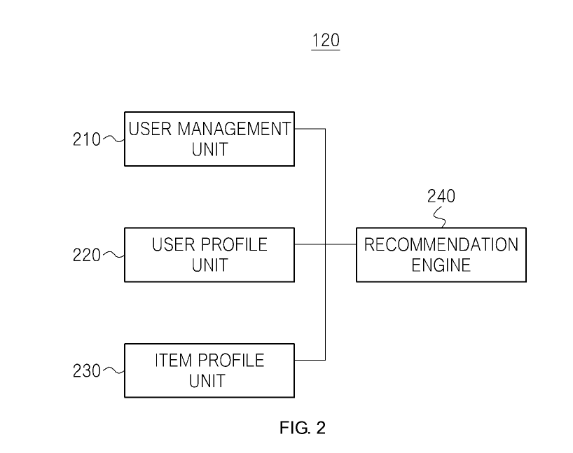

FIG. 2 is a block diagram illustrating a recommendation server in FIG. 1.

Referring to FIG. 2, the recommendation server 120 includes a user management unit 210, a user profile unit 220, an item profile unit 230 and a recommendation engine 240.

The user management unit 210 obtains query user information. In one embodiment, the query user information may be obtained through an account used when a corresponding user logins. In another embodiment, when the corresponding user does not login, the query user information may estimate the query user based on cookie information. Herein, the cookie information may include a previously used account.

The user profile unit 220 includes user profile information for a plurality of users. Each of user profile information may include a gender, an age, a residence and an occupation and may be generated when each of the plurality of the users joins. In one embodiment, the user profile information for the plurality of the users may be stored by a group. For example, each of the user profile information may be classified based on the gender, the age, the residence and the occupation to be stored.

In one embodiment, the user profile unit 220 may further include interest item information for each of the plurality of the users. In one embodiment, the interest item information may be determined based on at least one item being previously purchased by a corresponding user. In another embodiment, the interest item information may be determined based on at least one item where a corresponding user recently searches for at least one item. In the other embodiment, the interest item information may be determined based on at least one item where a corresponding user directly input at least one item.

The item profile unit 230 includes item profile information for the plurality of the items. Each of the item profile information may be classified by a group. For example, when item corresponds to a movie, the item profile information may be classified based on a genre, an actor or actress and a director to be stored.

The recommendation engine 240 searches for at least one recommendation item based on the query user, an item selected or searched by the query user or an interested item (hereinafter, referred to as a reference item).

In one embodiment, the recommendation engine 240 may predict a preference of a query user for a non-reference item based on a preference of other users similar to a preference of the query user. In another embodiment, the recommendation engine 240 may predict the preference of the query user for the non-reference item based on a similarity between the reference item and the non-reference item.

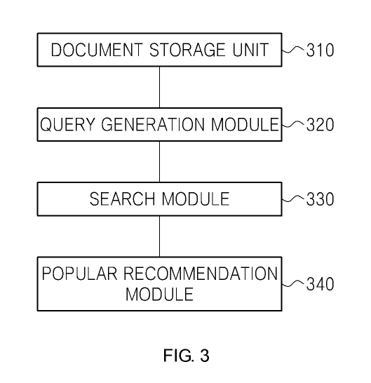

FIG. 3 is a block diagram illustrating a recommendation engine of FIG. 2.

Referring to FIG. 3, the recommendation engine 240 may include a document storage unit 310, a query generation module 320 and a search module 330 and may further include a popular recommendation module 340.

The document storage unit 310 stores a plurality of documents.

In one embodiment, the document storage unit 310 may store a plurality of item vectors as the plurality of the documents. The plurality of the item vectors and the plurality of the documents may be mapped with one-to-one correspondence. Herein, an item vector corresponds to a vector for an item including a preference of the user and may include an element including a user-preference pair. For example, n-th item vector may be defined as follows.

ITEMn=(ratingn,1,ratingn,2, . . . ratingn,m).

Herein, the ratingn,m corresponds to a preference of m-th user for n-th item.

In another embodiment, the document storage unit 310 may store a plurality of user vectors as the plurality of the documents. The plurality of user vectors and the plurality of the documents may be mapped with one-to-one correspondence. Herein, a user vector corresponds to a vector for user for a preference of the item and may include an element including an item-preference pair. As a result, each of the plurality of the user vectors may be formed by an element including an item-preference pair. For example, n-th item vector may be defined as follows.

USERm=(ratingm,1,ratingm,2, . . . ratingm,n)

Herein, the ratingm,n corresponds to a preference of n-th user for m-th item.

The query generation module 320 generates a query based on the query user information or reference item information.

In one embodiment, the query generation module 320 may search the plurality of the documents being stored in the document storage unit 310 for a reference document associated with the reference item to extract a reference item vector. The query generation module 320 may generate a query including the at least one user associated with the reference item vector.

In another embodiment, the query generation module 320 may search the plurality of the documents stored the document storage unit 310 for a reference document associated with the query user to extract a reference user vector. The query generation module 320 may generate a query including at least one item associated with the reference user vector.

The search module 330 searches at least one recommendation item based on the query. In one embodiment, the search module 330 may calculate a correlation between the reference item vector and each of the plurality of the item vectors in the plurality of the documents based on the query. In another embodiment, the search module 330 may calculate a correlation between the reference user vector and each of the plurality of the user vectors in the plurality of documents based on the query. In the above embodiment, the correlation may be calculated by using a Pearson Coefficient.

The search module 330 may predict a preference of the query user for the plurality of the items (e.g., the non-reference item) based on the correlation to search for at least one recommendation item.

The popular recommendation module 340 may determine at least one recommendation item independent of the reference item or the query user. In one embodiment, the popular recommendation module 340 may determine, as the at least one recommendation item, at least item frequently searched by the plurality of the users. In one embodiment, the popular recommendation module 340 may be used when the query user accesses the recommendation server 120 for a first time and a preference item of the query user is unknown. In this case, the item profile unit 230 may store a search number being updated in real time for each of the plurality of the items and the popular recommendation module 340 may obtain the search number for the plurality of the items from the item profile unit 230.

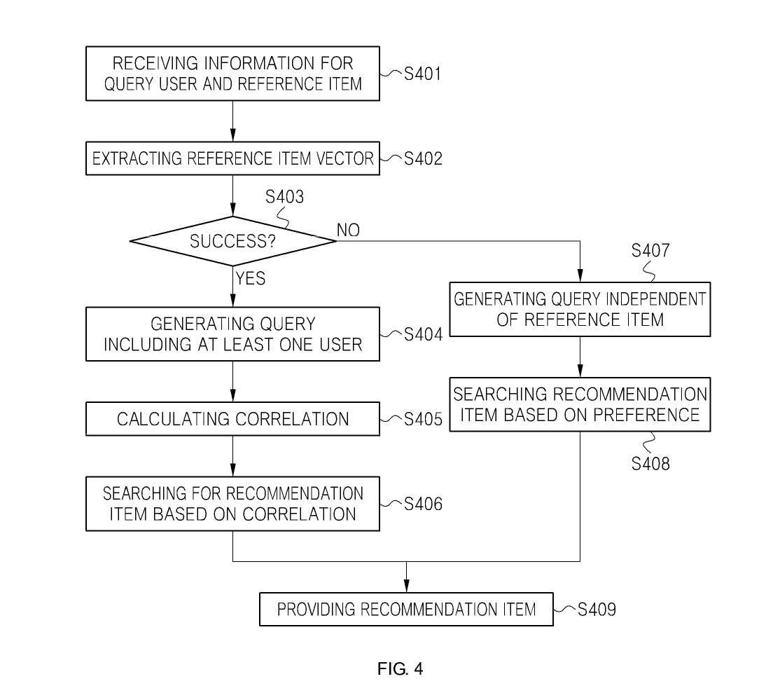

FIG. 4 is a diagram illustrating a first procedure recommending an item in a recommendation engine of FIG. 3.

Referring to FIG. 4, the recommendation engine 240 may provide the item based recommendation item to the query user.

When the query user select an item, the recommendation server 120 may transfer the query user information and the reference item information to the recommendation engine 240. Herein, the reference item information is assumed to correspond to information for at least one item selected by the query user.

The recommendation engine 240 receives the query user information and the reference item information Step S401 and the query generation module 320 searches the document storage unit 310 for the reference document associated with the reference item to extract the reference item vector Step S402.

The document storage unit 310 may store the plurality of the item vectors as the plurality of the documents and the plurality of the item vectors may be represented as the user and the preference and may be stored in the document storage unit 310 with the following type.

Item(i)={User(j):R(j)}(0≦i,natural number,0≦j,a natural number)

Herein, the Item(i) may correspond to a document. A maximum value of i corresponds to a number of the item and a maximum value of j corresponds to a number of the user. The R(j) indicates a preference for the item i of the user j.

For example, when the query user selects an item k (0≦k≦i), the query generation module 320 may search the document storage unit 310 for the Item(k) as the reference document to extract the reference item vector.

If the search is successful, the query generation module 320 generates a query including at least one user best associated with the reference item vector Steps S403 through S404.

In one embodiment, the query may be represented as at least one user and an operator and may be generated with the following type.

Query=“User(1)|User(2)| . . . |User(j)”(0≦j,a natural number)

A maximum value of the j corresponds to a number of the user and | corresponds to an OR operator.

For example, when the query generation module 220 generates “User(1)|User(2)|User(3)”, the search module 330 may search for the plurality of the documents including at least one among User(1), User(2), User(3) to extract the plurality of the item vectors.

In another embodiment, the query may define at least one user as query element. In one embodiment, the query element may include at least a corresponding preference as a boost and a corresponding user as a clause (or a terminology). In another embodiment, the query element may include at least a constant independent of a corresponding preference as a boost and a corresponding user as a clause (or a terminology). Herein, the boost may be used to determine a weight of the terminology.

The query may include a following tree structure.

<tree structure>

| | | |
|---|---|---|
| | the query −+−− a boost | |
| | +−− a clause −+− an element list −+− an element | −+− a type |
| | | +− a boost |
| | | +−a terminology {a user |
| field, a user} | | |

The boost may correspond to the preference or the constant and the element list may include at least one element. The type may be used to determine a terminology or a kind of operators and the user field may indicate for searching the plurality of the item vectors for a user. The user may represent one of at least one user.

The search module 330 calculates a correlation between the reference item vector and each of the plurality of the item vector in the plurality of the documents based on the query Step S405.

The search module 330 may search for the plurality of the documents including at least of the at least one user in the query to extract the plurality of the item vectors.

The search module 330 may calculate a correlation between the reference item vector and each of the plurality of the extracted item vectors. In one embodiment, the correlation may be calculated by using the Pearson Coefficient.

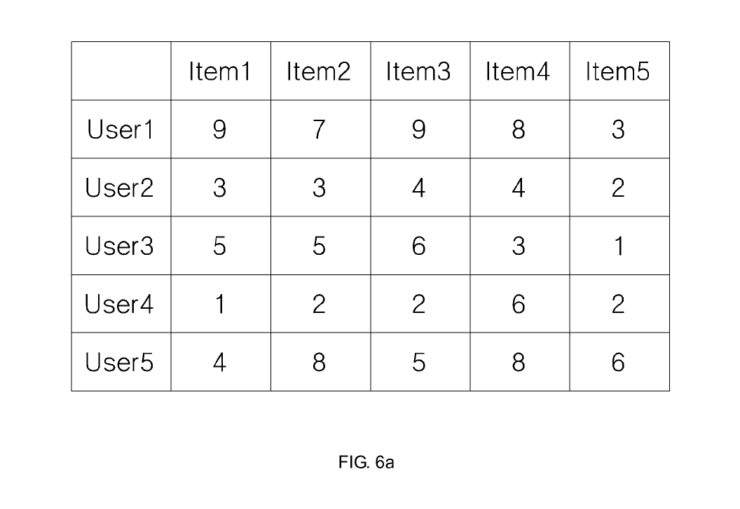

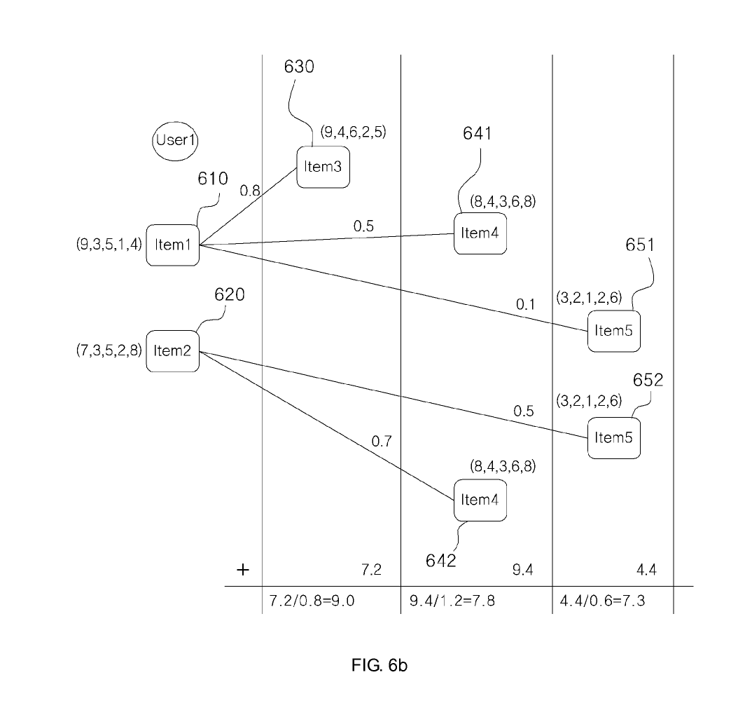

The search module 330 searches for at least one recommendation item based on the correlation Step S406. In one embodiment, the search module 330 may search for at least one recommendation item having best ranking among the plurality of the item vectors. The ranking may be calculated based on the preference of the query user and the correlation. For example, the ranking may be calculated by a product of the preference and the correlation of the query user for the reference item. When a number of the reference item is plural, the ranking may be calculated as an average of the product of the preference and the correlation of the query user for each of a plurality of reference items. A detailed example will be described in FIG. 6.

If the search is unsuccessful, the query generation module 320 generates a query including a query user independent of the reference item Steps S403 through S407.

The search module 330 searches for at least one recommendation item based on a preference of the query user for the plurality of the item vectors Step S408. For example, the search module 330 may search the plurality of the item vectors for the query user to determine at least one item having a best corresponding preference as the at least recommendation item.

In one embodiment, if the search is unsuccessful, the popular recommendation module 340 may determine, as at least one recommendation item, at least one item recent frequently searched in a current time window and independent of the reference item.

The recommendation item 120 provides at least one recommendation item to the query user Step S409.

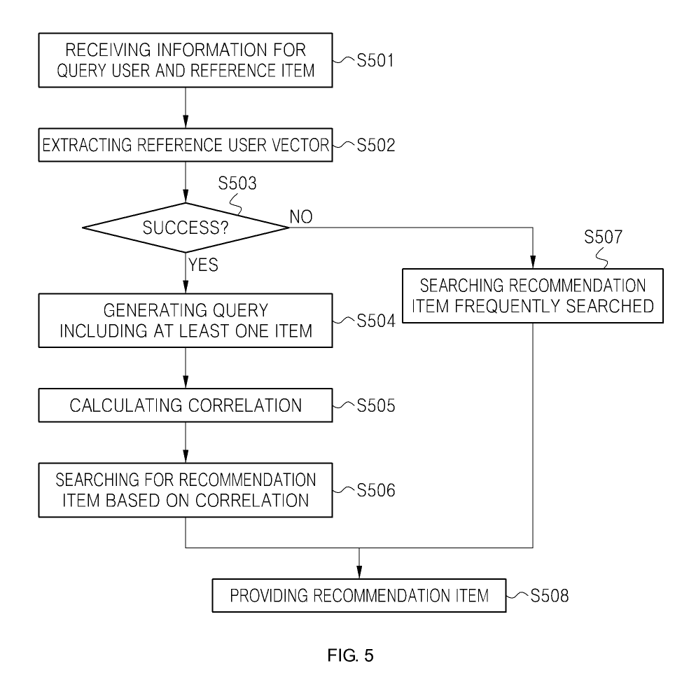

FIG. 5 is a diagram illustrating a second procedure recommending an item in a recommendation engine of FIG. 3.

Referring to FIG. 5, the recommendation engine 240 may provide the user based recommendation item to the query user.

When the query user selects an item, the recommendation server 120 may transfer the query user information and the reference item information to the recommendation engine 240. Herein, the reference item information is assumed to correspond to information for at least one item selected by the query user.

When the recommendation engine 240 receives the query user information and the reference item information Step S501, the query generation module 320 searches the document storage unit 310 for the reference document associated with the query user to extract a reference user vector Step S502.

The document storage unit 310 may store the plurality of the user vectors as the plurality of the documents and the plurality of the user vectors may be represented as the user and the preference and may be stored in the document storage unit 310 with the following type.

User(i)={Item(j):R(j)}(0≦i,natural number,0≦j,a natural number)

Herein, the User(i) may correspond to a document. A maximum value of corresponds to a number of the user and a maximum value of the j corresponds to a number of the item. The R(j) indicates a preference for the user i of the item j.

For example, when the query user k(0≦k≦i) selects a reference item, the query generation module 320 may search the document storage unit 310 the document storage unit 310 for the User(k) as the reference document to extract the reference user vector.

If the search is successful, the query generation module 320 generates a query including at least one item best associated with the reference user vector Steps S503 through S504.

In one embodiment, the query may be represented as at least one item and an operator and may be generated with the following type.

Query=“Item(1)|Item(2)| . . . |Item(j)”(0≦j,a natural number)

A maximum value of the j corresponds to a number of the item and | corresponds to an OR operator.

For example, when the query generation module 220 generates “Item(1)|Item(2)|Item(3)”, the search module 330 may search for the plurality of the documents including at least one among Item(1), Item(2), Item(3) to extract the plurality of the user vectors.

In another embodiment, the query may define at least one item as query element. In one embodiment, the query element may include at least a corresponding preference as a boost and a corresponding item as a clause (or a terminology). In another embodiment, the query element may include at least a constant independent of a corresponding preference as a boost and a corresponding item as a clause (or a terminology). Herein, the boost may be used to determine a weight of the terminology.

The query may include a following tree structure.

<tree structure>

| | | |
|---|---|---|
| | the query −+−− a boost | |
| | +−− a clause −+− an element list −+− an element | −+− a type |
| | | +− a boost |
| | | +−a terminology {an item |
| field, an item} | | |

The boost may correspond to the preference or the constant and the element list may include at least one element. The type may be used to determine a terminology or a kind of operators and the item field may indicate for searching the plurality of the item vectors for a user. The item may indicate one of the at least one item.

The search module 330 may calculate a correlation between the reference user vector and each of the plurality of the user vectors in the plurality of the documents based on the query Step S505.

The search module 330 may search for the plurality of the user vectors including one of at least one item in the query.

The search module 330 may calculate a correlation between the reference user vector and each of the plurality of the extracted user vectors. In one embodiment, the correlation may be calculated by using the Pearson Coefficient.

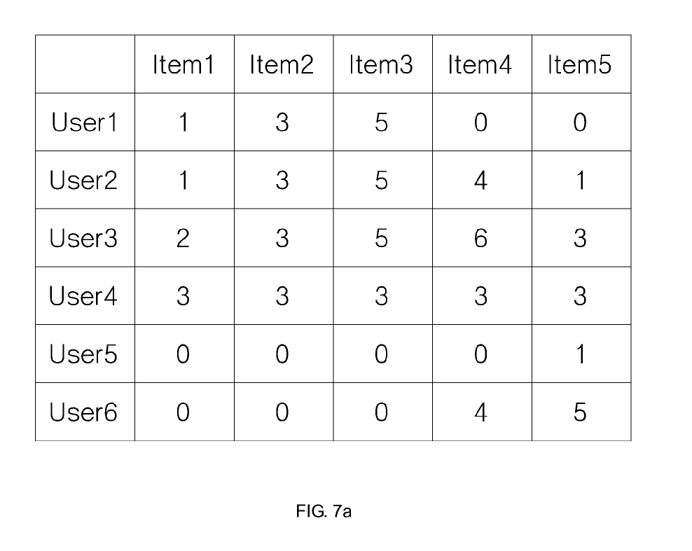

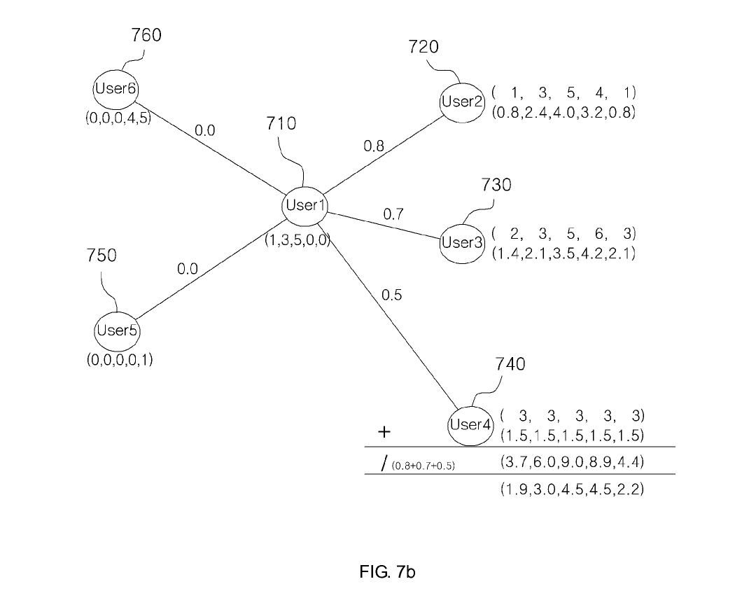

The search module 330 searches for at least one recommendation item based on the correlation Step S506. In one embodiment, the search module 330 may search for at least one recommendation item having a best ranking based on the plurality of the user vectors. The ranking may be calculated based on the preference and the correlation of the plurality of the users. For example, the ranking may be calculated with an average for a product of the preference and the correlation of each of the plurality of the user vectors. A detailed example will be described in FIG. 7.

If the search is unsuccessful, the popular recommendation module 340 may determine, as at least one recommendation item, at least one item recent frequently searched in a current time window and independent of the query user Steps S503 through S507.

The recommendation server 120 provides at least one recommendation item to the query user Step S508.

FIG. 6 is a diagram illustrating an example of a first procedure recommending an item of FIG. 4.

Referring to FIG. 6a and FIG. 6b, the document storage unit 310 is assumed to store User(1) through User(5) and the query user is assumed to correspond to User(1) and the reference item is assumed to correspond to Item(1) and Item(2).

When the recommendation engine 240 receives information for User(1) and Item(1) and Item(2), the query generation module 320 may search the document storage unit 310 for the reference document associated with Item(1) and Item(2) to extract first and second reference item vectors 610 and 620. Herein, the first reference item vector 610 is {User(1):9, User(2):3, User(3):5, User(4):1, User(5):4} and the second reference item vector 620 is {User(1):7, User(2):3, User(3):5, User(4):2, User(5):8}.

The query generation module 320 may generate a query including User(1), User(2), User(3), User(4) and User(5) associated with the reference item vectors. The query may be indicated as follow

Query=“User(1)|User(2)|User(3)|User(4)|User(5)”

The search module 330 may search for the first and second reference item vectors 610 and 620 and third through fifth item vectors 630 through 650 to calculate a correlation between each of the first and second reference item vectors 610 and 620 and the third through fifth item vectors 630 through 650.

In one embodiment, the correlation may calculated by using the Pearson Coefficient. The Pearson Coefficient may measure a degree of linear relationship between two variables and may be represented as the following mathematics.

$$CORRELATION OF ( ITEM ( k ) , ITEM ( 𝓁 ) ) = \frac{{\sum }_{i = 1}^{m} ( {R}_{k} ( i ) - {\overline{R}}_{k} ) ( {R}_{𝓁} ( i ) - {\overline{R}}_{𝓁} )}{\sqrt{{\sum }_{i = 1}^{m} {( {R}_{k} ( i ) - {\overline{R}}_{k} )}^{2}} \sqrt{{\sum }_{i = 1}^{m} {( {R}_{𝓁} ( i ) - {\overline{R}}_{𝓁} )}^{2}}}$$

Herein, m represents a number of the user, the Rₖ(i) represents a preference of a user i for an item k and Rₗ(i) represents a preference of a user i for an item l. The R̅ₖ and R̅ₗ indicate an average of a preference of m users for items k and l.

A value of a correlation between the first reference item vector 610 and the third item vector 630 is assumed to 0.8, a value of a correlation between the first reference item vector 610 and the fourth item vector 640 is assumed to 0.5 and a value of a correlation between the first reference item vector 610 and the fifth item vector 650 is assumed to 0.1. And it is assumed that a value of a correlation between the second reference item vector 620 and the fourth item vector 640 is assumed to 0.5 and a value of a correlation between the second reference item vector 620 and the fifth item vector 650 is assumed to 0.7.

In one embodiment, the search module 330 may select a high ranking item vector. The ranking may be calculated based on the preference and the Pearson Coefficient. For example, the search module 330 may select an item vector where a value of the Pearson Coefficient is more than and equal to 0.5 and a value of the preference of the query user is more than or equal to 5. The search module 330 may select the third and fourth item vectors 630 and 640 in FIG. 6b and may predict the preference of the query user for the plurality of the items based on the selected item vector.

The search module 330 may multiply a preference in each of the first and second reference item vectors 610 and 620 and a correlation for each of the third through fifth item vectors 630 through 650 to calculate an average for each of the plurality of the items. For example, a preference of a query user for Item(4) search the first and second reference item vectors 610 and 620 for a preference of User(1) to respectively multiply a correlation for the fourth item vector 640. The search module 330 may obtain a preference calculated in below by adding all results and dividing the all results into a sum of the correlation.

{(9*0.5)+(7*0.7)}/1.2=7.8

The search module 330 may predict a preference of a query user for Item(4) as 7.8. The search module 330 may determine at least one recommendation item based on the predicted preference of the query user. For example, when a number of the recommendation item being provided from the recommendation server 120 is 2, the search module 330 may provide Item(3) and Item(4) with the first and 20 second reference items to the query user.

FIG. 7 is a diagram illustrating an example of a second procedure recommending an item of FIG. 5.

Referring to FIG. 7a and FIG. 7b, the document storage unit 310 is assumed to store User(1) through User(5) as a document and a query user is assumed to correspond to User(1) and a reference item is assumed to correspond to Item(1).

When the recommendation engine 240 receives information for User(1) and Item(1), the query generation module 320 may search the document storage unit 310 for a reference document associated with User(1) to extract a reference user vector 710. The reference user vector is {Item(1):1, Item(2):3, Item(3):5, Item(4):0, Item(5):0}.

The query generation module 320 may generate a query including Item(1), Item(2), Item(3), Item(4) and Item(5) associated with the reference user vector. The query may be indicated as follow.

Query=“Item(1)|Item(2)|Item(3)|Item(4)|Item(5)”

The search module 330 may search for a document including at least one among Item(1) through Item(5) to extract second through sixth user vectors 620 through 660. The search module 330 may calculate a correlation between the reference user vector and each of the second through sixth user vectors 720 through 760.

In one embodiment, the correlation may be calculated by using the Pearson Coefficient. The Pearson Coefficient may measure a degree of linear relationship between two variables and may be represented as the following mathematics.

$$CORRELATION OF ( USER ( k ) , USER ( 𝓁 ) ) = \frac{{\sum }_{i = 1}^{m} ( {R}_{k} ( i ) - {\overline{R}}_{k} ) ( {R}_{𝓁} ( i ) - {\overline{R}}_{𝓁} )}{\sqrt{{\sum }_{i = 1}^{m} {( {R}_{k} ( i ) - {\overline{R}}_{k} )}^{2}} \sqrt{{\sum }_{i = 1}^{m} {( {R}_{𝓁} ( i ) - {\overline{R}}_{𝓁} )}^{2}}}$$

Herein, m represents a number of the item, the Rₖ(i) represents a preference of a user k for an item i and Rₗ(i) represents a preference of a user k for an item i. The R̅ₖ and R̅ₗ indicate an average of a preference of user k and l for m items.

A value of a correlation between the reference user vector 710 and the second user vector 720 is assumed to 0.8, a value of a correlation between the reference user vector 710 and the third user vector 730 is assumed to 0.7 and a value of a correlation between the reference user vector 710 and the fourth user vector 740 is assumed to 0.5, a value of a correlation between the reference user vector 710 and the fifth user vector 750 is assumed to 0 and a value of a correlation between the reference user vector 710 and the sixth user vector 760 is assumed to 0.

In one embodiment, the search module 330 may select a user vector having a high ranking. The ranking may be calculated based on the preference and the Pearson Coefficient. For example, the search module 330 may select a user vector where a value of the Pearson Coefficient is more than or equal to 0.5 and a preference of a query user is similar to a preference for a reference item. The search module 330 may select the second and third user vectors 720 and 730 in FIG. 7b and may predict the preference of the query user for the plurality of the items based on the selected user vector.

The search module 330 may multiply a preference of each of the plurality of the items in the second through sixth user vectors 720 through 760 and a corresponding correlation to calculate an average for each of the plurality of items. For example, a preference of a query user for Item(4) search the second through fourth user vectors 720 through 740 for a preference of Item(4) to multiply each of the corresponding correlation. The search module 330 may obtain a preference calculated in below by adding all results and dividing the all results into a sum of the correlation.

{(4*3.2)+(6*4.2)+(3*1.5)+(0*0)+(4*0)}/2=4.5

The search module 330 may predict a preference of a query user for Item(4) as 4.5. The search module 330 may determine at least one recommendation item based on the predicted preference of the query user. For example, when a number of the recommendation item being provided from the recommendation server 120 is 2, the search module 330 may provide Item(3) and Item(4) with the reference item to the query user.

Although embodiments have been described with reference to a number of illustrative embodiments thereof, it should be understood that numerous other modifications and embodiments can be devised by those skilled in the art that will fall within the spirit and scope of the principles of this disclosure.

1. A recommendation engine searching for at least one recommendation item associated with a reference item, the reference item being selected by a query user, the recommendation engine comprising:
a query generation module configured to store a plurality of item vectors as a plurality of documents, configured to search for a reference document associated with the reference item among the plurality of the documents to extract a reference item vector and configured to generate a query including at least one user best associated with the extracted reference item vector if successful, each of the plurality of the item vectors corresponding to an element including a user-preference pair; and
a search module configured to calculate a correlation between the extracted reference item vector and each of the plurality of the item vectors in the plurality of the documents based on the generated query to provide the at least one recommendation item.

2. The recommendation engine of claim 1, wherein the search module calculates a correlation between a preference of the at least one user and a preference of at least one user in each of the plurality of the item vectors.

3. The recommendation engine of claim 2, wherein the correlation is calculated by using a Pearson Coefficient.

4. The recommendation engine of claim 3, wherein the query defines each of the at least one user as a query element and the query element includes at least a corresponding preference as a boost and a corresponding user as a terminology.

5. The recommendation engine of claim 4, wherein the search module searches for at least one item vector having best ranking among the plurality of the item vectors based on the query element.

6. The recommendation engine of claim 5, wherein the ranking is calculated based on the boost and the Pearson Coefficient.

7. The recommendation engine of claim 1, wherein the query defines each of the at least one user as a query element and the query element includes at least a constant independent of a corresponding preference as a boost and a corresponding user as a terminology.

8. The recommendation engine of claim 1, further comprising:
a popular recommendation module configured to determine, as the at least one recommendation item, at least one item recent frequently searched in a current time window and independent of the reference item if unsuccessful.

9. The recommendation engine of claim 1, wherein the query generation module generates a query including the query user independent of the reference item if unsuccessful.

10. The recommendation engine of claim 9, wherein the search module searches the plurality of the item vectors for the query user to determine at least one item having a best preference as the at least recommendation item.

11. The recommendation engine of claim 1, wherein a structure of the query includes a following tree structure.
<tree structure>

| | | |
|---|---|---|
| the query | −+−− a boost | |
| | +−− a clause −+− an element list −+− an element | −+− a type |
| | | +− a boost |
| | | +− a terminology {a user field, |
| a user} | | |

(the boost corresponds to a preference, the element list may include at least one element, the type is used to determine a terminology or a kind of operators, the user field indicates for searching the plurality of the item vectors for a user and the user indicates one of the at least one user)

12. An item recommendation method performed by a recommendation engine searching for at least one recommendation item associated with a reference item, the reference item being selected by a query user, the method comprising:
storing a plurality of item vectors as a plurality of documents and searching for a reference document associated with the reference item among the plurality of the documents to extract a reference item vector;
generating a query including at least one user best associated with the extracted reference item vector if successful; and
calculating a correlation between the extracted reference item vector and each of the plurality of the item vectors in the plurality of the documents based on the generated query to provide the at least one recommendation item
wherein each of the plurality of the item vectors corresponds to an element including a user-preference pair.

13. The item recommendation method of claim 12, further comprising:
determining, as the at least one recommendation item, at least one item recent frequently searched in a current time window and independent of the reference item if unsuccessful.

14. The item recommendation method of claim 12, further comprising:
generating a query including the query user independent of the reference item if unsuccessful; and
searching the plurality of the item vectors for the query user to determine at least one item having a best preference as the at least recommendation item.
